(19) United States
(12) Patent Application Publication
(10) Pub. No.: US 2006/0261149 A1
(43) Pub. Date: Nov. 23, 2006

(54) Automated teller machine with receipt printer and display

(75) Inventor: Gupta Sesha Raghavendra Tulluri, Surrey Hills (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 11/132,521

(22) Filed: May 18, 2005

(51) Int. Cl. G07F 19/00

(52) U.S. Cl. 235/379

(57) ABSTRACT

In one embodiment, a method enables a receipt to be provided to a user through a variety of options. Such options may include a paper receipt that is printed using a printer, a display of the receipt on the display screen, an electronic copy of the receipt that is transmitted to a mobile communications device, or an electronic copy of the receipt that is transmitted to an email address. The user is able to select one of these options using an input device, whereupon the receipt is provided according the selected option.

### BACKGROUND OF THE INVENTION

This invention relates generally to the field of receipts, and in particular with options for receiving receipts. In one specific application, the invention relates to the selection of a particular form of a receipt from a machine, such as a kiosk or automated teller machine.

Automated teller machines (or ATMs) are widely used throughout the world. With most ATMs, after performing a transaction, a paper receipt is automatically generated. Often, these receipts are discarded without being used. As such, they account for a significant amount of wasted paper. Paper receipts are also generated with machines like gas pumps, ticketing machines, and the like. As with ATMs, these receipts are often discarded as well.

### BRIEF SUMMARY OF THE INVENTION

In certain embodiments, the invention provides systems and methods that provide a person with options for receiving receipts, paper or otherwise. For example, when using a machine having a display screen and an input device, the user may be shown a variety of options on the display screen. These could include a paper receipt printed using a printer in the machine, a display of the receipt on the display screen, an electronic copy of the receipt, or a combination of any of these options. For electronic copies, the machine may be used to transmit a signal that allows the receipt to be sent to an email account or address, a wireless communications device, such as a mobile phone, PDA, wireless email device or the like. In doing so, a variety of formats may be used, such as an SMS text message, a pdf file, a spreadsheet, or the like. One particular advantage of using electronic receipts is that paper is not used, thereby conserving an important natural resource.

In some options, the user may pre-register for a given option so that each time a receipt is to be generated, it is provided according to the selected option. This may be done by contacting a service center, by using one of the machines, or the like.

The receipts may be granted for a variety of reasons. For example, the receipt could be for a purchase (e.g., gasoline, airline tickets, etc.), for a cash withdrawal, for a deposit into a bank account, when using a credit card or a debit card, for a balance inquiry or transfer, and the like.

A wide variety of machines may be configured to provide various types of receipts. In one particular embodiment, the machine may include a housing, a display screen, a processor, an input device, a printer and an output communications device. The display screen may be used to display the various receipt options, and the input device may be used to select one ore more of the options. Depending on the selected option, the printer may be used to print a paper receipt, or the communications device may be used to transmit a signal to a host computer, switch, or the like, in order to provide an electronic copy of the receipt to a mobile phone, email address, PDA, or the like. In some cases, the communications device may transmit or “beam” the electronic receipt directly to a wireless device using a variety of technologies, such as Blue Tooth, so that the user can instantly receive a copy of the receipt. In other cases, the user could connect a personal computing device to the machine to receive the receipt, such as by a USB connection.

Such machines may be used in a variety of transactions. For example, the machine could be an ATM for making financial transactions. Other machines include gas pumps, ticket dispensers, and the like.

### BRIEF DESCRIPTION OF THE DRAWINGS

FIG. 1 illustrates one embodiment of a kiosk which provides the user with various options for receiving a receipt according to the invention.

FIG. 2 illustrates one embodiment of a display screen for providing the user with various options for receiving a receipt according to the invention.

FIG. 3 illustrates one embodiment of a display screen showing a copy of a receipt according to the invention.

FIG. 4 illustrates an embodiment of a display screen permitting the user to enter an email address or mobile number for electronic delivery of the receipt according to the invention.

FIG. 5 illustrates an embodiment of a display screen giving the user various options for receiving future receipt according to the invention.

FIG. 6 illustrates one embodiment of a system that may be used to provide a user with various types of receipts according to the invention.

### DETAILED DESCRIPTION OF THE INVENTION

The present invention provides a variety of machines, such as kiosks, gas pumps, ticket dispensers, automated teller machines, point of sale devices, and the like that allow any one of a variety of transactions or inquiries to occur. These functions may include dispensing cash, dispensing financial instruments, making purchases, transferring funds, purchasing gasoline, purchasing phone cards, making balance inquiries, viewing statements, performing money transfers, making deposits, and the like.

With each of these, the user may be provided with a receipt. Examples of such machines include ATMs as are known in the art (such as the one described in copending U.S. application Ser. No. 10/225,410, filed Aug. 20, 2002, incorporated herein by reference), point of sale devices as are known in the art (such as those described in U.S. Pat. Nos. 6,886,742 and 6,827,260, incorporated herein reference), gas pumps, ticket dispensers and other machines where receipts are generated.

In one aspect of the invention, the user is given multiple options for receiving a receipt. In this way, the user can receive a traditional paper receipt or other form, such as an electronic copy that is delivered to an email account or some type of wireless device. One example of how to wirelessly transmit electronic receipts is described in copending U.S. application Ser. No. 10/273,436, filed Oct. 16, 2002, the complete disclosure of which is herein incorporated by reference.

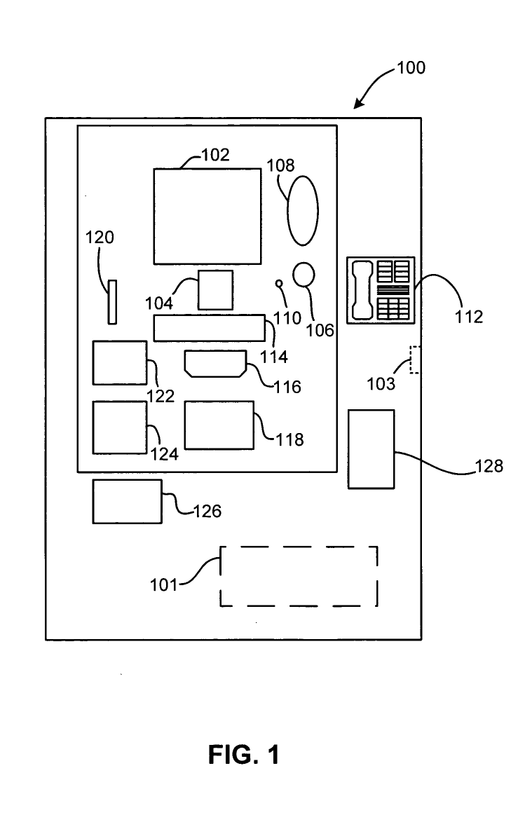

FIG. 1 illustrates one example of a kiosk 100 according to one embodiment of the invention that may be used to provide multiple options for receiving a receipt. The kiosk 100 is presented as an illustration only, and this example should not be considered limiting. In light of the disclosure herein, many other examples of kiosks according to the present invention are apparent to those skilled in the art, as well as other types of receipt-producing machines.

Kiosks, such as the multi-purpose kiosk 100, may be located wherever customers might obtain access to them. For example, shopping malls, airports, postal facilities, banks and the like, would all be ideal locations for such kiosks. Kiosks may be connected to a network, such as a financial transaction network, via a wire line or wireless connection using an output communications interface 103. A computing device, such as a central processor 101, controls many of the functions of the kiosk.

The kiosk 100 includes a monitor 102 and a keypad 104. The monitor may include a touch screen that allows users to enter information by touching buttons displayed on the screen. Alternatively or additionally, users may enter information using a keypad 104. The keypad 104 may contain both numbers and letters. Additionally, the keypad 104 may include special purpose buttons for selecting functions according to the invention.

The kiosk 100 also includes a camera 106, a speaker 108, and a microphone 110. The camera 106, speaker 108, and microphone 110 may be used to interact with a customer service representative, among other functions. The customer service representative's image may appear on the monitor 102. Alternatively or additionally, a telephone 112 may be used to interact with the customer service representative.

The kiosk 100 also includes a cash dispenser 114 and a coin dispenser 116. A cash/check scanner 118 is provided for receiving funds in the form of currency or certain types of paper instruments. For example, an optical character reader, such ad a MICR reader, may be used to read account information from checks, money orders, and other negotiable instruments. In addition, a card reader 120, such as a Hypercom terminal, is provided for using any of a wide variety of currency exchange media. For example, the card reader 120 may read magnetic strips, such as those commonly found on credit and debit cards, customer loyalty cards, value cards, and the like. The card reader 120 may also read “chips,” such as those associated with certain types of “smart cards.” The card reader 120 may also read other types of currency exchange media, including infrared and radio frequency devices. For instance, a customer may be able to “beam” account information into the card reader 120 using an infrared transmitter associated with a PDA (personal digital assistant). Thus, reader 120 may perform any of a wide variety of reading functions. Additionally, the card reader 120 may be able to write information to value cards, and the like. A transmitter may also be used to directly “beam” receipt information to a PDA.

The kiosk 100 also includes a receipt printer 122, a money order printer 124, and a cash card dispenser 126. The receipt printer 122 provides users with receipts of transactions and other information, as will be explained in more detail hereinafter. The money order printer 124 prints money orders in amounts requested by users, as will be described. Example of money order printers are described in more detail in U.S. patent application Ser. No. 6,015,087, entitled “Apparatus and Method For Issuing Documents Of Value,” which patent is incorporated herein by reference in its entirety, and in U.S. patent application Ser. No. 09/751,126, entitled “Money Order Encashment Via The FDX 400,” filed on Dec. 28, 2000, by Earney Stoutenburg et al., which application is incorporated herein by reference. The cash card dispenser 126 dispenses cash cards, or other value cards, that may store value or store account information that users may use to access currency or other value. The cash card dispenser 126 may be used in combination with the card reader 120, wherein the cash card dispenser 126 dispenses value cards and the card reader 120 writes information to the value cards. The kiosk 100 may also contain holders such as marketing material holder 128 for educating users regarding the use of the kiosk 100, or to provide users with supplies needed in the course of conducting transactions using the kiosk 100.

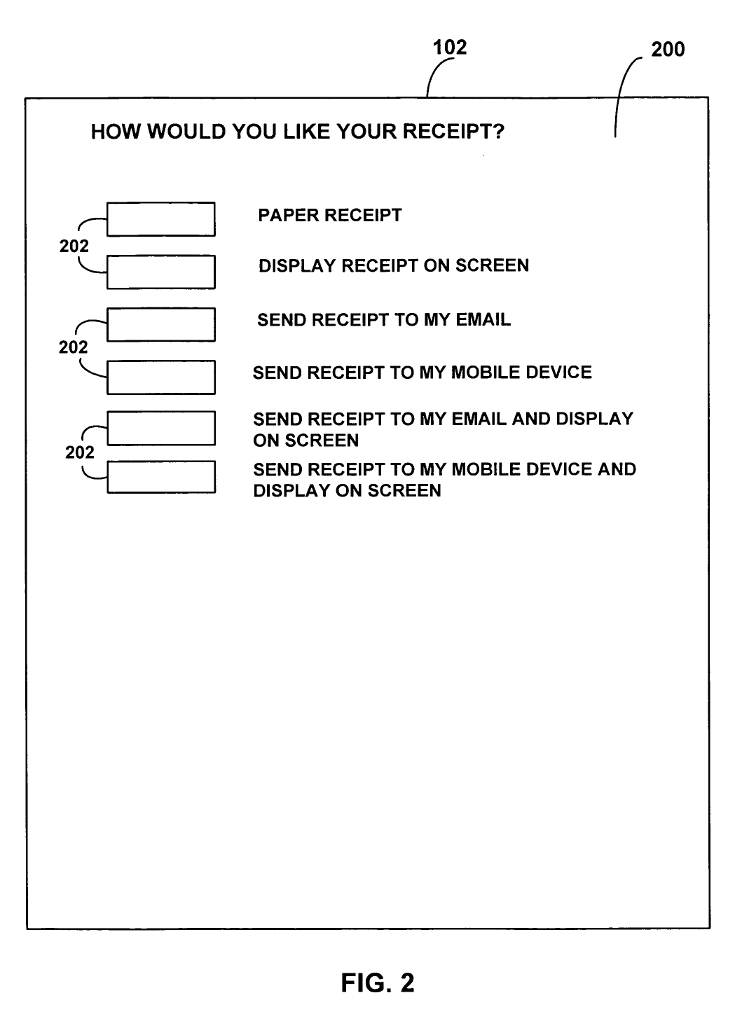

FIG. 2 illustrates one embodiment of a display 200 that may be presented on monitor 102. Display 200 presents the user with various options for receiving a receipt for a transaction. Associated with each option is an icon 202 that may be touched to select the given option. As an alternative, kiosk 100 could include physical buttons adjacent display 200 that could be pressed to select the desired option. As a further option, keypad 104 could be used.

As shown, the user may select from options such as receiving a paper receipt that is printed using printer 122, a display of the receipt that is shown on monitor 102, sending the receipt to an e-mail address, or sending the receipt to a mobile device. Also, the user may select any combinations of the above, such as for example, by displaying the receipt and the display screen as well as sending the receipt to an email address and/or to a mobile device. Examples of e-mail accounts include those that may be accessed using a personal desk top or laptop computer, a PDA, a mobile phone or the like. The electronic copy of the receipt may be delivered in a variety of formats, such as a pdf document, a Word® document, in a spreadsheet, in a TIFF image file format, as a JPEG or the like. When sending the receipt to a mobile phone, the receipt may be transmitted as an SMS text file, or if the mobile phone includes an operating system such as Windows CE, other formats as described above may be used.

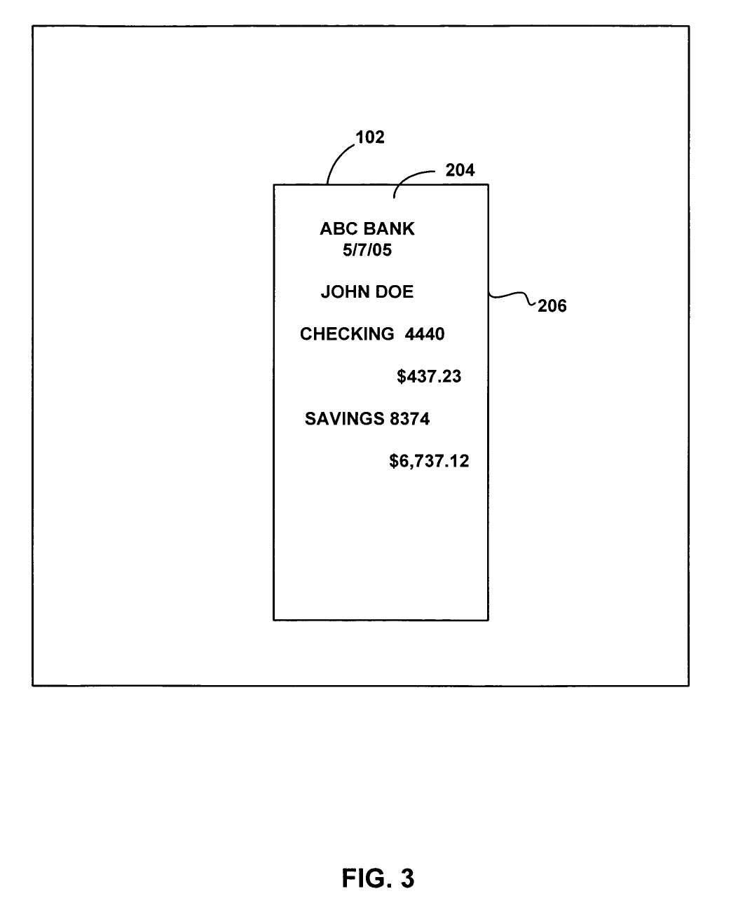

FIG. 3 illustrates an embodiment of a display 204 that may be displayed on monitor 102 when the user requests that the receipt by displayed on monitor 102. Shown is a copy of the receipt 206. In this case, the user has requested to see current balances for his financial accounts. In other cases, the user could select to see receipts showing withdrawals, deposits, balance transfers, statement, bills and the like.

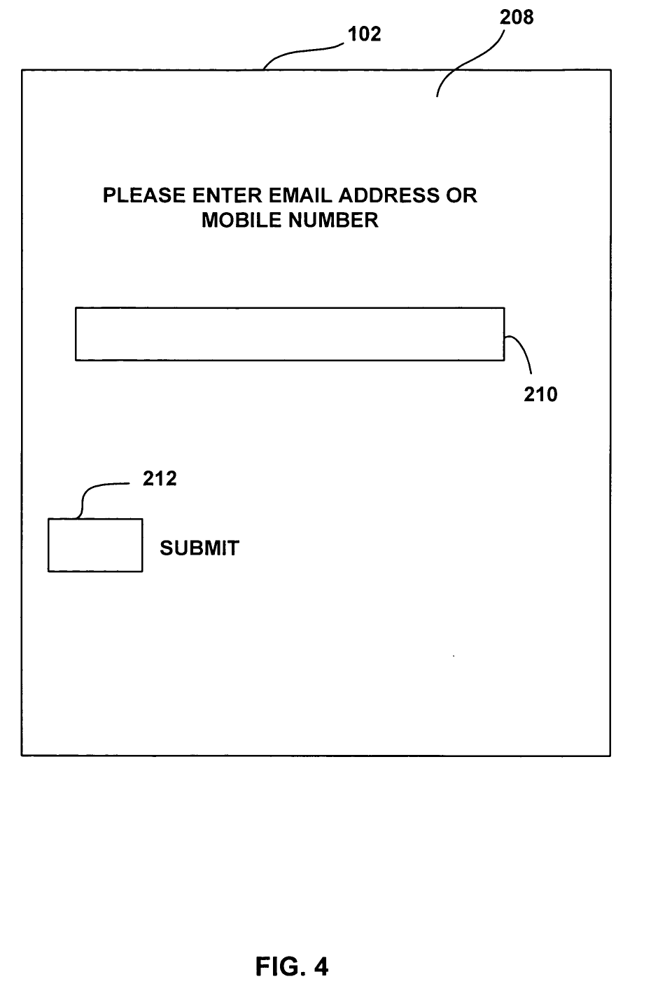

FIG. 4 illustrates a display 208 that may be shown on monitor 102 when the user selects an option for an electronic copy of a receipt. Display 208 includes an entry box 210 where the user may input an email address or a mobile number where the electronic copy of the receipt may be transmitted. This information may be input using keypad 104. When ready to send, a submit icon 212 is selected. In one option, the user could also be presented with another screen that lets the user select a format in which the user would like to receive the file.

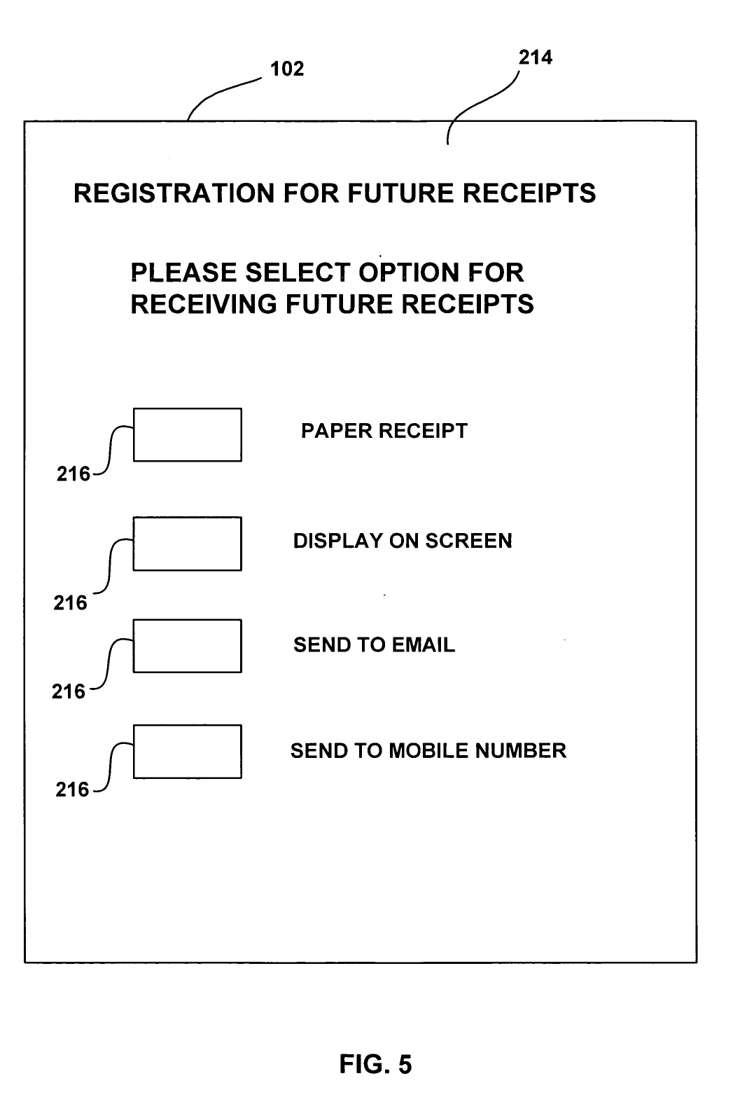

In some cases, the user may wish to register a certain option as a default. In this way, the receipt will automatically be sent to the pre-selected option. FIG. 5 shows one embodiment of a display 214 that may be shown on monitor 102 that permits a user to register an option. Icons 216 may be pressed or touched to select the desired option. If needed, additional screens may appear to permit the user to input additional information, such as an email address, mobile phone number, or physical address where a receipt could be mailed. Also, in some cases, the user may be permitted to select more than one option for receiving the receipt. For example, the user may wish both a printed copy and an electronic copy. Further, in some cases, the user may be presented with additional options for which the user is charged a fee, such as when mailing a copy of the receipt.

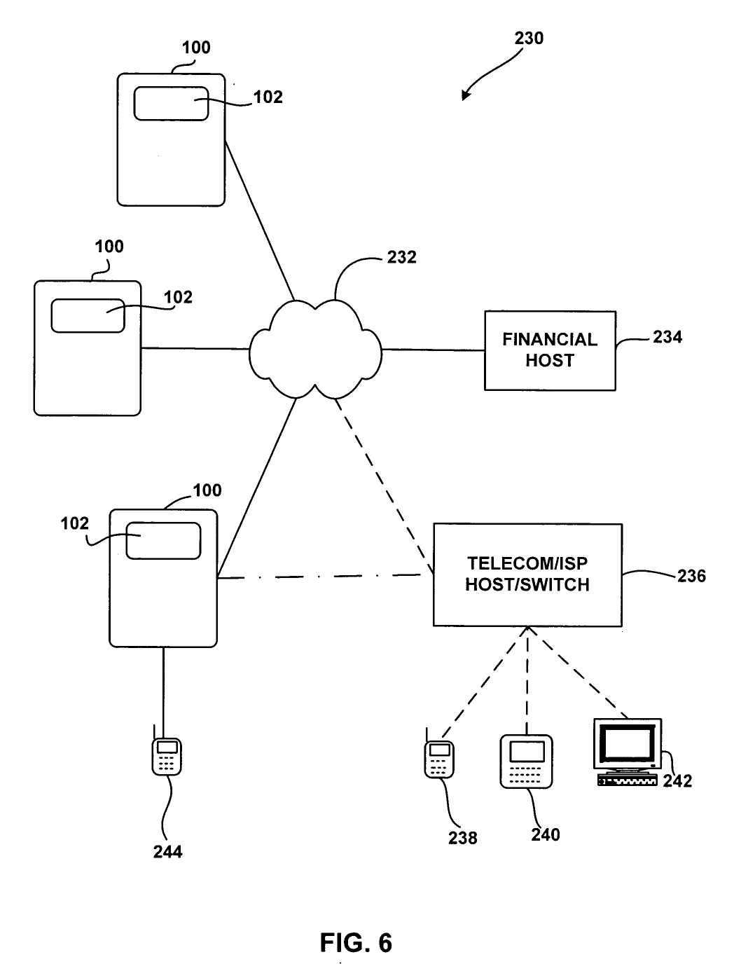

FIG. 6 illustrates a system 230 within which one or more kiosks may be used. The system includes a plurality of kiosks 100, each connected to the other in an environment via a network 232. The network 232 may be any of a wide variety of networks, including, for example, a wide area network, a local area network, the Internet, a credit/debit network over which credit and/or debit transactions occur, and the like.

Also coupled to network 232 is a financial host 234 that may include appropriate processors and databases for conducting financial transactions over network 232 as is known in the art. For example, financial host 234 may be used to conduct credit, debit and/or stored value transactions as is known the art. Merely be way of example, if a user wishes to withdraw money from kiosk 100, this transaction may be transmitted through network 232 and to financial host 234 where appropriate authorizations are performed and a record of the transaction is maintained. Further, it will be appreciated to those of skill in the art that financial host 234 may communicate with other computer systems to complete such transactions. Hence, the invention is not intended to be limited to a specific type of transaction but may be performed by financial host 234, but it will be appreciated that essentially any type of known transaction may be performed in accordance with the principles described herein. Also coupled to network 232 and/or financial host 234 and/or kiosks 100 is a telecommunications or Internet service provider host/switch 236. Host/switch 236 may be used to facilitate communications with a variety of wireless devices. For example, if a user wishes to receive an electronic copy of a receipt using kiosk 100, a copy of the electronic receipt may be transmitted to host/switch 236 directly from kiosk 100 over some type of network, including network 232, or via financial host 234. When host/switch 236 receives the electronic copy of the receipt along with the forwarding information, it may forward it to an appropriate email address, mobile number, or the like. This may also be done over a variety of networks as is known in the art. As one example, if the user wishes the electronic receipt to be sent as a text message or other message to a mobile phone 238, host/switch 236 may be configured to send the electronic copy to the mobile phone 238 over an appropriate network. Similarly, a PDA or other hand held computer 240 may receive an electronic copy of a receipt from host/switch 236 in a similar manner. Further, if the user wishes to send the electronic receipt to an email address, this may be accomplished using host/switch 236 which will forward to the receipt to a user's email when using a personal computer 242 or other type of computer capable of receiving and reading emails.

In some cases, kiosk 100 may be configured to directly transmit an electronic copy of the receipt to a mobile device. For example, shown in FIG. 6 is a mobile phone 244 or other hand held device may directly receive a communication from kiosk 100 using Blue Tooth technology, other IR technology, a USB port, or the like. In this way, the electronic receipt would not need to be transmitted over network 232 or use host/switch 236.

The invention has now been described in detail for purposes of clarity and understanding. However, it will be appreciated that certain changes and modifications may be practiced within the scope of the appended claims.

What is claimed is:

1. A machine, comprising:
a housing;
a display screen associated with housing;
an input device;
an output communications device;
a printer that is configured to print receipts; and
a processor that is configured to produce on the display screen options for receipting a receipt, wherein the options include at least two of: a paper receipt printed using the printer, a display of the receipt on the display screen, an electronic copy of the receipt transmitted to a mobile communications device using the output communications device, and an electronic copy of the receipt transmitted to an email address using the output communications device, and wherein the input device is configured to receive a selection of one of the options.

2. A machine as in claim 1, wherein the input device is selected from a group consisting of a keyboard and the display screen.

3. A machine as in claim 1, wherein the output communications device is configured to transmit the electronic copy of the receipt to a switch for transmission to the mobile communications device or the email address.

4. A machine as in claim 1, wherein the receipt is selected from a group consisting of receipts for: purchases, statements, withdrawals, transfers, balances, and deposits.

5. A method for providing a receipt using a machine having a display screen, a printer and an input device, the method comprising:
displaying on the display screen options for receiving a receipt, wherein the options include at least two of: a paper receipt printed using the printer, a display of the receipt on the display screen, an electronic copy of the receipt transmitted to a mobile communications device, and an electronic copy of the receipt transmitted to an email address;
selecting one of the options using an input device; and
providing the receipt as selected using the input device.

6. A method as in claim 5, wherein the selected option comprises the electronic copy of the receipt that is transmitted to the mobile communications device, and further comprising entering a mobile phone number using the input device.

7. A method as in claim 5, wherein the selected option comprises the electronic copy of the receipt that is transmitted to the email address, and further comprising entering the email address using the input device.

8. A method as in claim 5, wherein the receipt is selected from a group consisting of receipts for: purchases, statements, withdrawals, transfers, balances, and deposits.

9. A method as in claim 5, further comprising selecting one of the options as a default option for future receipts.

10. A method as in claim 5, wherein the option is selected by pressing a key of the input device.

11. A method as in claim 5, wherein the option is selected by touching an icon on the display screen.

12. A method as in claim 5, further comprising transmitting the electronic copy of the receipt to a switch for transmission to the mobile communications device.

13. A method for providing a receipt using a machine having a display screen, a printer and an input device, the method comprising:
registering for an option for receiving a receipt;
storing the registration at a host computer system;
requesting a receipt from a machine having a display screen, a printer and an input device;
transmitting from the host computer system to the machine the registered option; and
using the machine to provide the receipt with the registered option.

14. A method as in claim 13, wherein the option is selected from a group consisting of a paper receipt printed using the printer, a display of the receipt on the display screen, an electronic copy of the receipt transmitted to a mobile communications device, and an electronic copy of the receipt transmitted to an email address.
